(19) United States
(12) Patent Application Publication
(10) Pub. No.: US 2009/0079669 A1
(43) Pub. Date: Mar. 26, 2009

(54) FLAT PANEL DISPLAY

(75) Inventors: Tzu-Chien Huang, Taoyuan County (TW); Hsien-Chun Wang, Taoyuan County (TW); Ting-Chang Hsu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 12/177,888

(22) Filed: Jul. 23, 2008

(30) Foreign Application Priority Data
Sep. 26, 2007 (TW) 96135673

(51) Int. Cl. G09G 3/00

(52) U.S. Cl. 345/30

(57) ABSTRACT

A flat panel display is provided. The flat panel display includes a display panel, a gate driver, a source driver and a signal switching unit. The gate driver outputs a gate signal. The signal switching unit turns on the first terminal and the second terminal thereof to deliver the gate signal to a first scan line during a preceding half period of a frame period. Moreover, the signal switching unit turns on the first terminal and the third terminal thereof during a rear half period of the frame period, so that the gate signal, which is previously delivered to the first scan line, is delivered to the second scan line at this time. In this way, the source driver drives the display panel in coordination with the gate signal delivered by the first and second scan lines.

### CROSS-REFERENCE TO RELATED APPLICATION

This application claims the priority benefit of Taiwan application serial no. 96135673, filed on Sep. 26, 2007. The entirety of the above-mentioned patent application is hereby incorporated by reference herein and made a part of this specification.

### BACKGROUND OF THE INVENTION

1. Field of the Invention

The present invention generally relates to a flat panel display, and more particularly, to a flat panel display able to reduce the number of employed gate drivers thereof.

2. Description of Related Art

With the development in photoelectric technology and semiconductor manufacturing process, flat panel display (FPD) has become the most popular display apparatus. Among various products of flat panel display, because of the advantages of low-voltage operation, unharmful radiation, light weight, and compact size, liquid crystal display (LCD) has become the major product in the FPD market. Consequentially, how to improve the LCD has gradually become a significant issue for the LCD manufactures.

FIG. 1 is a circuit diagram of a conventional LCD 100. Referring to FIG. 1, a conventional LCD 100 includes a gate driver 110, a source driver 120, and a display panel 130. The display panel 130 of the LCD 100 includes n×m pixel units arranged in an array, where n and m are positive integers. For example, four pixel units of the display panel 130 are notated by P1-P4. In addition, scan lines SCL₁-SCLₙ are respectively electrically connected to an output terminal of the gate driver 110, while data lines DAL₁-DALₘ are respectively electrically connected to an output terminal of the source driver 120.

As shown in FIG. 1, because the display panel 130 has n rows of the pixel units, the gate driver 110 must have n output terminals so as to deliver a gate signal to the display panel 130 respectively through the scan lines SCL₁-SCLₙ. Similarly, because of the m columns of the pixel units of the display panel 130, the source driver 120 must have m output terminals so as to deliver a data signal to the display panel 130 respectively through the data lines DAL₁-DALₘ. In this way, each pixel unit of the display panel 130 can be driven by the received gate signals and data signals.

However, since the increasing demand for the resolution of the conventional LCD 100 leads to the growth of the pixel units in the display panel 130, if the numbers of the output terminals of the provided gate driver 110 and source driver 120 are fixed, more gate driver 110 and source driver 120 should be added in the LCD 100 to achieve higher resolution. Moreover, because the gate driver and source driver are expensive, the production cost of an LCD that employs more gate drivers and/or more source drivers is accordingly increased with a prolonged manufacturing schedule. Therefore, if the numbers of the employed gate drivers and/or the source drivers can be reduced, it will provide a solution to easily decrease the cost and shorten the manufacturing schedule.

In order to solve the above-mentioned problems, the US Publication No. 2006/0022202 provides a scheme to reduce the number of the employed source drivers in an LCD. FIG. 2 is a circuit diagram of a conventional LCD 200. Referring to FIG. 2, a conventional LCD 200 includes a gate driver 210, a source driver 220, a signal generator 230, and a display panel 240. The display panel 240 includes pixel units P1-P4, and the two pixel units P1 and P2 coupled to the same scan lines SCL₁ are electrically connected to the same data lines DAL₁ respectively via switches SW21 and SW22. Similarly, the two pixel units P3 and P4 coupled to the same scan lines SCL₂ are also electrically connected to the same data lines DAL₁ respectively via switches SW23 and SW24.

FIG. 3 is a signal timing diagram of the LCD 200 in FIG. 2, and FIGS. 4A and 4B are diagrams that respectively illustrate the phenomenon of the display panel 240 shown in FIG. 2 within different periods. Referring to FIGS. 2-4B, when the signal generator 230 produces a control signal CLK1 during a preceding half period T11 of a frame period T1, the switches SW21 and SW23 are turned on, and the switches SW22 and SW24 are turned off. At that time, in response to gate signals VG₁-VGₙ received from the gate driver 210, the pixel units P1 and P3 of the LCD 200 are driven in sequence within the preceding half period T11, as shown in FIG. 4A. Similarly, when the signal generator 230 outputs a control signal CLK2 during a rear half period T12 of the frame period T1, the switches SW22 and SW24 are turned on, and the switches SW21 and SW23 are turned off. Thus, in response to the gate signals VG₁-VGₙ, the pixel units P2 and P4 of the LCD 200 are driven in sequence within the rear half period T12, as shown in FIG. 4B.

It is obvious from the above described, in comparison with the conventional LCD 100, the number of the data lines employed in the LCD 200 can be reduced to a half of the number of the data lines employed in the LCD 100. In other words, in the condition that both the source driver 120 and the source driver 220 use the source drivers having pins of the same number to achieve the same resolution, the conventional LCD 200 is operable by using fewer source drivers than the LCD 100.

It should be noted that, in the prior art, each of the pixel units in the display panel 240 should be coupled to a corresponding switch. Therefore, the aperture ratio of the display panel 240 is reduced, and the circuits of the pixel units in the display panel 240 become more complicated. In addition, since each pixel unit is connected to a corresponding switch, the charging time of each pixel unit would be reduced to a half of the original charging time. Thus, the charging time of each pixel becomes insufficient, and the display quality of the LCD is degraded accordingly.

### SUMMARY OF THE INVENTION

Accordingly, the present invention is directed to a flat panel display. The flat panel display delivers the same gate signal to a plurality of scan lines within a frame period by using a signal switching unit such that the number of the gate drivers employed in the flat panel display could be reduced.

The present invention is also directed to a flat panel display. The flat panel display uses a fewer number of the employed gate drivers without modifying the circuit architecture of a conventional display panel so as to effectively lower down the production cost of the flat panel display and shorten the manufacturing schedule accordingly.

The present invention also provides a flat panel display. The flat panel display includes a display panel, a gate driver, a source driver, and a signal switching unit. The display panel herein includes a first scan line and a second scan line. The signal switching unit has a first terminal, a second terminal and a third terminal, wherein the first terminal is electrically connected to the output terminal of the gate driver, the second terminal is electrically connected to the first scan line of the display panel, and the third terminal is electrically connected to the second scan line of the display panel.

The gate driver outputs a gate signal through the output terminal. During a preceding half period of a frame period, the signal switching unit turns on the first terminal and the second terminal so that the gate signal output from the gate driver is delivered to the first scan line. In addition, during a rear half period of a frame period, the signal switching unit turns on the first terminal and the third terminal such that the gate signal is delivered to the second scan line instead of the first scan line. In this way, the source driver drives the display panel by delivering the gate signal via the first scan line and the second scan line.

The present invention further provides a flat panel display. The flat panel display includes a display panel, a gate driver, a source driver, a signal generator and a signal switching unit. The display panel herein includes a first scan line and a second scan line. The signal switching unit has a first terminal, a second terminal, and a third terminal. The first terminal is electrically connected to the output terminal of the gate driver, the second terminal is electrically connected to the first scan line of the display panel, and the third terminal is electrically connected to the second scan line of the display panel.

The gate driver is used to output a gate signal through the output terminal thereof. The signal generator generates a first control signal and a second control signal in sequence during a frame period. The signal switching unit turns on the first terminal and the second terminal thereof according to the first control signal such that the gate signal output from the gate driver is delivered to the first scan line. Besides, the signal switching unit turns on the first terminal and the third terminal thereof according to the second control signal so that the gate signal, which is previously delivered to the first scan line, is delivered to the second scan line at the time. In this way, in coordination with the gate signals delivered by the first scan line and the second scan line, the source driver drives the display panel.

The present invention further provides a flat panel display. The flat panel display includes a display panel, a gate driver, a source driver and a signal switching unit. The display panel herein includes a first scan line, a second scan line, and a third scan line. The signal switching unit has a first terminal, a second terminal, a third terminal, and a fourth terminal. The first terminal is electrically connected to the output terminal of the gate driver, the second terminal is electrically connected to the first scan line of the display panel, the third terminal is electrically connected to the second scan line of the display panel, and the fourth terminal is electrically connected to the third scan line of the display panel.

In more detail, the gate driver is used to output a gate signal through the output terminal thereof. The signal switching unit turns on the first terminal and the second terminal thereof during a preceding period of a frame period such that the gate signal output from the gate driver is delivered to the first scan line. Besides, the signal switching unit turns on the first terminal and the third terminal thereof during an intermediate period of a frame period so that the gate signal, which is previously delivered to the first scan line, is delivered to the second scan line at the time. Similarly, the signal switching unit turns on the first terminal and the fourth terminal thereof during a rear period of a frame period so that the gate signal, which is previously delivered to the second scan line, is delivered to the third scan line. In this way, in coordination with the gate signals delivered by the first scan line, the second scan line and the third scan line, the source driver drives the display panel.

The present invention further provides a flat panel display. The flat panel display includes a display panel, a gate driver, a source driver, a signal generator, and a signal switching unit. The display panel herein includes a first scan line, a second scan line, and a third scan line. The signal switching unit has a first terminal, a second terminal, a third terminal, and a fourth terminal. The first terminal is electrically connected to the output terminal of the gate driver, the second terminal is electrically connected to the first scan line of the display panel, the third terminal is electrically connected to the second scan line of the display panel, and the fourth terminal is electrically connected to the third scan line of the display panel.

In terms of the overall operation, the gate driver is used to output a gate signal through the output terminal thereof. The signal generator generates a first control signal, a second control signal, and a third control signal in sequence during a frame period. The signal switching unit turns on the first terminal and the second terminal thereof according to the first control signal such that the gate signal output from the gate driver is delivered to the first scan line. The signal switching unit also turns on the first terminal and the third terminal thereof according to the second control signal so that the gate signal, which is previously delivered to the first scan line, is delivered to the second scan line at the time. Besides, the signal switching unit turns on the first terminal and the fourth terminal thereof according to the third control signal so that the gate signal, which is previously delivered to the second scan line, is delivered to the third scan line at the time. In this way, in coordination with the gate signals delivered by the first scan line, the second scan line and the third scan line, the source driver drives the display panel.

Since the present invention adopts a signal switching unit, so that the same gate signal is able to be delivered to different scan lines during a frame period, and thereby the number of the employed gate drivers in a flat panel display is reduced, which contributes to lower down the production cost and the manufacturing schedule of a flat panel display.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional LCD 100.

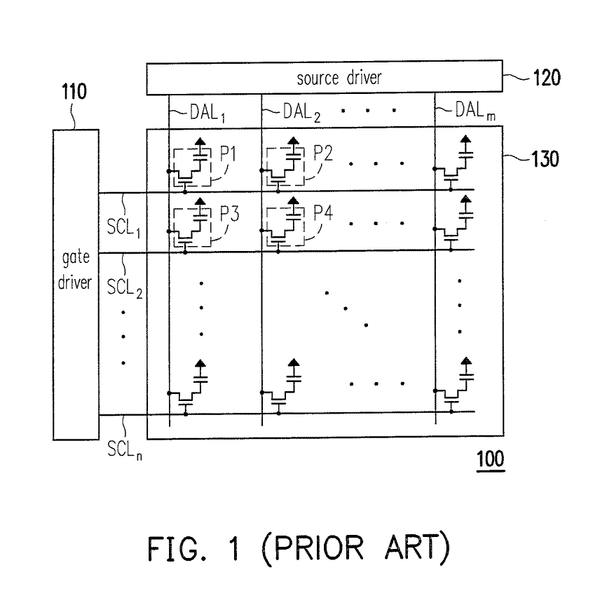

FIG. 2 is a circuit diagram of another conventional LCD 200.

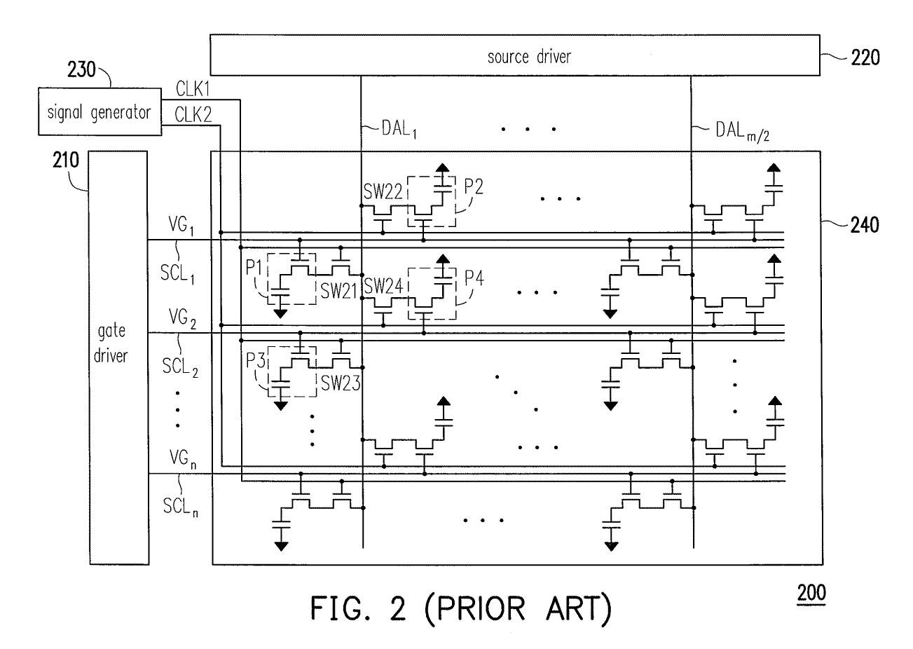

FIG. 3 is a signal timing diagram of the LCD 200 in FIG. 2.

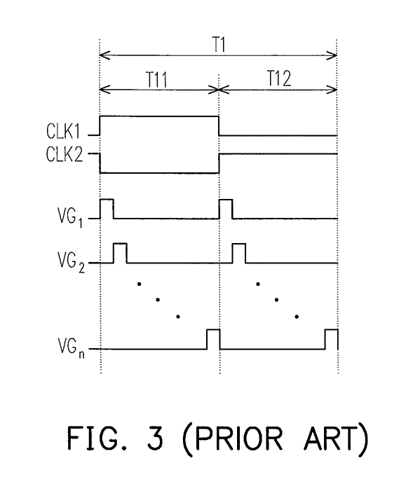

FIGS. 4A and 4B are diagrams respectively illustrating the phenomenon of the display panel 240 in FIG. 2 during different periods.

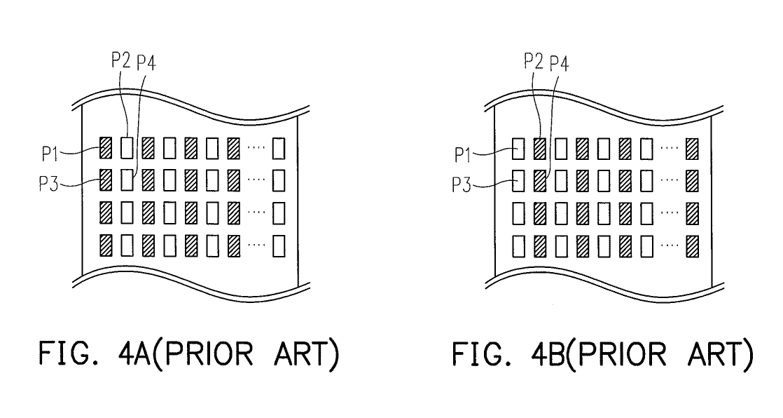

FIG. 5 is a circuit diagram of a flat panel display 500 according to an embodiment of the present invention.

FIG. 6 is a signal timing diagram showing the embodiment of FIG. 5,

FIGS. 7A and 7B are diagrams respectively illustrating the phenomenon of the display panel 510 in FIG. 5 during different periods.

FIG. 8 is a circuit layout diagram of a signal switching unit SU₅₁ of FIG. 5.

FIG. 9 is a circuit diagram of a flat panel display 900 according to another embodiment of the present invention.

FIG. 10 is a signal timing diagram showing the signal timing of FIG. 9.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

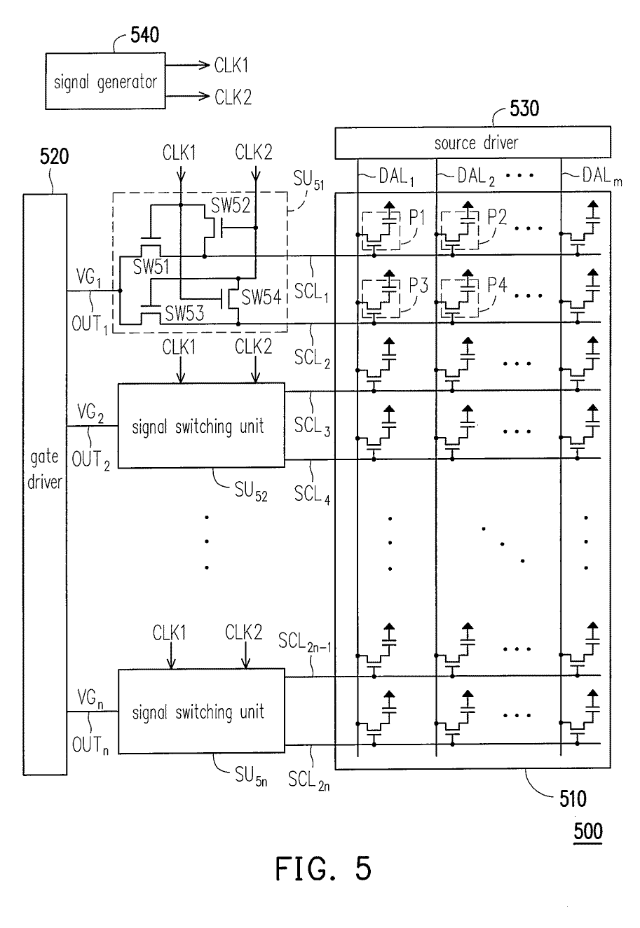

FIG. 5 is a circuit diagram of a flat panel display 500 according to an embodiment of the present invention. Referring to FIG. 5, a flat panel display 500 includes a display panel 510, a gate driver 520, a source driver 530 and at least a signal switching unit SU₅₁. Wherein, the display panel 510 includes two scan lines SCL₁ and SCL₂, data lines DAL₁-DALₘ and a plurality of pixel units (for example, the pixel units notated by P1-P4), and m is a positive integer. In addition, the display panel 510 is a liquid crystal display panel (LCD panel), and the connection relation of the pixel units P1-P4 is similar to that of the pixel units in the conventional LCD 100, thereby the description about the connections of the pixels units in the display panel 510 are omitted.

Referring to FIG. 5, the source driver 530 has m output terminals, through which the source driver 530 is electrically connected to the corresponding data lines DAL₁-DALₘ. The signal switching unit SU₅, is disposed between the gate driver 520 and the display panel 510, and has a first terminal, a second terminal and a third terminal. The first terminal of the signal switching unit SU₅₁ is electrically connected to the output terminal OUT₁ of the gate driver 520, and the second and third terminals of the signal switching unit SU₅₁ are respectively connected to the scan lines SCL₁ and SCL₂.

In more detail, the signal switching unit SU₅₁ includes switches SW51-SW54. The first terminals of the switches SW51 and SW53 are electrically connected to the output terminal OUT₁ of the gate driver 520, the second terminals of the switches SW51 and SW53 are respectively electrically connected to the scan lines SCL₁ and SCL₂, and control terminals of the switches SW51 and SW53 are respectively used to receive a control signal CLK1 and a control signal CLK2.

In addition, the first terminal of the switch SW52 is electrically connected to the control terminal of the switch SW51, the second terminal of the switch SW52 is electrically connected to the scan lines SCL₁, and the control terminal of the switch SW52 is used to receive the control signal CLK2. The first terminal of the switch SW54 is electrically connected to the control terminal of the switch SW53, the second terminal of the switch SW54 is electrically connected to the scan lines SCL₂, and the control terminal of the switch SW54 is used to receive the control signal CLK1.

It should be noted that although the switches SW51-SW54 are formed by using NMOS transistors, but anyone skilled in the art is allowed to change the internal architectures of the switches SW51-SW54 to meet the design consideration.

Based on the spirit of the embodiment, since the display panel 510 in the flat panel display 500 has 2n scan lines SCL₁-SCL₂ₙ, the flat panel display 500 should have n signal switching units SU₅₁-SU₅ₙ and the gate driver 520 should have n output terminals OUT₁-OUTₙ accordingly, wherein n is a positive integer. The connection relation of the signal switching units SU₅₂-SU₅ₙ with the output terminals OUT₂-OUTₙ and scan lines SCL₃-SCL₂ₙ are the similar to that of the signal switching unit SU₅₁ with the output terminal OUT₁ and scan lines SCL₁-SCL₂, thereby the description about the connections of the switching units SU₅₂-SU₅ₙ with the output terminals OUT₂-OUTₙ and scan lines SCL₃-SCL₂ₙ are omitted.

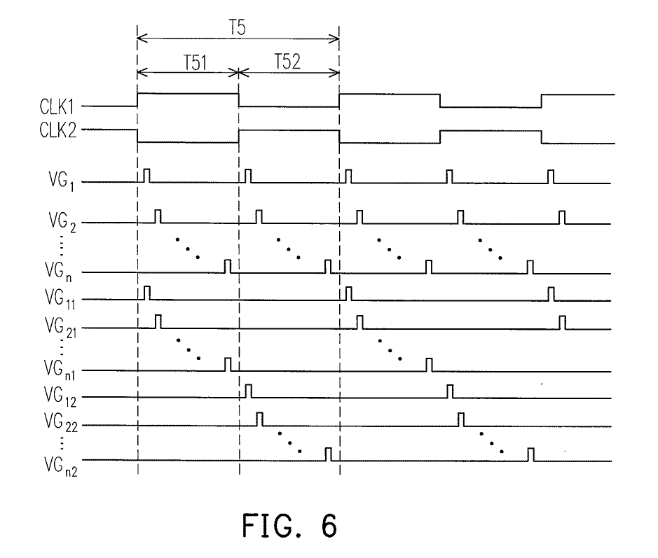

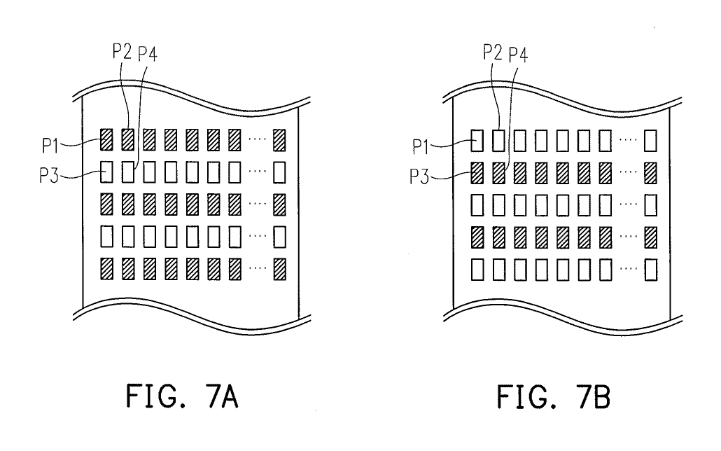

In order to make anyone skilled in the art understand the spirit of the embodiment more, FIG. 6 is provided to show the signal timing diagram of the embodiment in FIG. 5, and FIGS. 7A and 7B are provided to respectively illustrate the phenomenon of the display panel 510 in FIG. 5 within different periods. Referring to FIGS. 5-7B, the embodiment of the present invention is depicted in detail with the accompanying diagrams.

In terms of the overall operations, as shown in FIG. 6, it is assumed that the time for the display panel 510 to display one frame need a frame period T5, and the frame period T5 is divided into a preceding half period T51 and a rear half period T52. During the preceding half period T51 of the frame period T5, the first and second terminals of the signal switching units SU₅₁-SU₅ₙ would be respectively turned on so as to respectively pass the gate signals VG₁-VGₙ to the scan lines SCL₁, SCL₃, . . . , SCL₂ₙ₋₁. Similarly, during the rear half period T52 of the frame period T5, the first and third terminals of the signal switching units SU₅₁-SU₅ₙ are respectively turned on such that the gate signals VG₁-VGₙ are respectively passed to the scan lines SCL₂, SCL₄, . . . , SCL₂ₙ.

By taking the signal switching unit SU₅₁ as an example, the operation principle of the flat panel display 500 is depicted hereinafter. Referring to FIGS. 5 and 6, during the preceding half period T51 of the frame period T5, the control signal CLK1 is switched to a high level (for example, logic ‘1’), and the control signal CLK2 is switched to a low level (for example, logic ‘0’). Therefore, the switches SW51 and SW54 are respectively turned on, and the switches SW52 and SW53 are respectively turned off. Therefore, the gate signal VG₁ is delivered to the scan line SCL₁ through the turned-on switch SW51, and the control signal CLK2 is delivered to the scan line SCL₂ through the turned-on switch SW54. As shown in FIG. 7A, when the gate signal VG₁ is applied during the preceding half period T51, the pixel units P1 and P2 are driven by the source driver 530 in sequence. However, in the meanwhile, the pixel units P3 and P4 are not driven since they are controlled by the control signal CLK2.

Similarly, during the rear half period T52 of the frame period T5, the control signal CLK1 is switched to the low level and the control signal CLK2 is switched to the high level. Therefore, the switches SW52 and SW53 are respectively turned on, and the switches SW51 and SW54 are respectively turned off. At this time, the turned-on switch SW53 enables the scan line SCL₂ to receive the gate signal VG₁ and the turned-on switch SW52 enables the scan line SCL₁ to receive the control signal CLK1 and to be remained in the low level. As shown in FIG. 7B, when the gate signal VG₁ is applied during the rear half period T52, the pixel units P3 and P4 are driven by the source driver 530 in sequence. However, in the meanwhile, since pixel units P1 and P2 are controlled by the control signal CLK1, the pixel units P1 and P2 are not driven.

On the other hand, as shown in FIG. 6, if the gate signals VG₁-VGₙ received by the display panel 510 during the preceding half period T51 are re-named as VG₁₁-VGₙ₁ and the gate signals VG₁-VGₙ received during the rear half period T52 are re-named as VG₁₂-VGₙ₂, then under the control of the signal switching units SU₅₁-SU₅ₙ, the display panel 510 would receive the gate signals VG₁₁-VGₙ₁ respectively through the scan lines SCL₁, SCL₃, . . . , SCL₂ₙ₋₁ during the preceding half period T51. Similarly, the display panel 510 would receive the gate signals VG₁₂-VGₙ₂ respectively through the scan lines SCL₂, SCL₄ . . . , SCL₂ₙ during the rear half period T52. Since periods of the gate signals VG₁₁-VGₙ₁ and the gate signals VG₁₂-VGₙ₂ are not overlapped each other in the timing, thus, the pixel units in the display panel 510 are driven in sequence.

Note that the flat panel display 500 further includes a signal generator 540 electrically connected to the signal switching units SU₅₁-SU₅ₙ. The signal generator 540 generates the control signals CLK1 and CLK2 to control the signal switching units SU₅₁-SU₅ₙ, so that the signal switching units SU₅₁-SU₅ₙ, are able to decide whether to turn on the first and second terminals thereof according to the control signal CLK1 and whether to turn on the first and third terminals thereof according to the control signal CLK2.

Besides, on the transmission path through which the signal generator 540 outputs the control signal CLK1 to the signal switching units SU₅₁-SU₅ₙ, parasitic resistance and parasitic capacitance may result in a delay effect (that is, the parasitic resistance and parasitic capacitance would increase the rising time and the falling time of the control signals CLK1 and CLK2). To avoid the delay effect, as shown in FIG. 6, the time point for switching the control signals CLK1 and CLK2 is prior to that for enabling the gate signal VG₁, so that the control signals CLK1 and CLK2 have sufficient time to be switched to the expected level, and the switches in the signal switching units SU₅₁-SU₅ₙ is not to be turned on or turned off at an unexpected time.

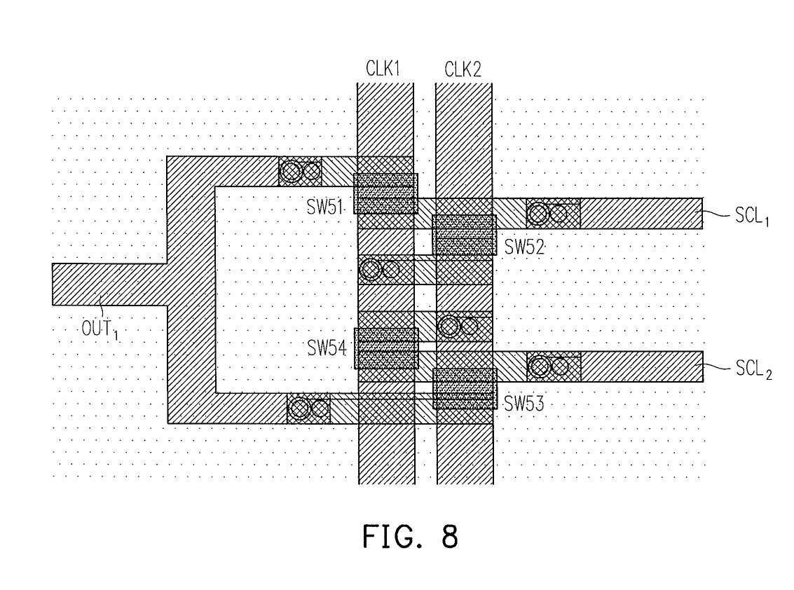

FIG. 8 is a circuit layout diagram of a signal switching unit SU₅₁ of FIG. 5. As shown in FIG. 8, the signal switching unit SU₅₁ is implemented by an appropriate layout of the switches SW51-SW54 to reduce the layout area of the circuit. In addition, it can be seen from the above-mentioned embodiment, the same gate signal is sent to two different scan lines within one frame period. For example, during the frame period T5, the gate signal VG₁ is delivered in sequence to the scan lines SCL₁ and SCL₂. In this way, when the display panel 510 has n scan lines, the gate driver 520 only requires n/2 output terminals to make the flat panel display 500 operable.

In other words, in the condition that the flat panel displays 100, 200 and 500 use the gate drivers having pins of the same number to achieve the same resolution, the flat panel display 500 of the present invention is operable by using fewer gate drivers than the conventional flat panel displays 100 and 200.

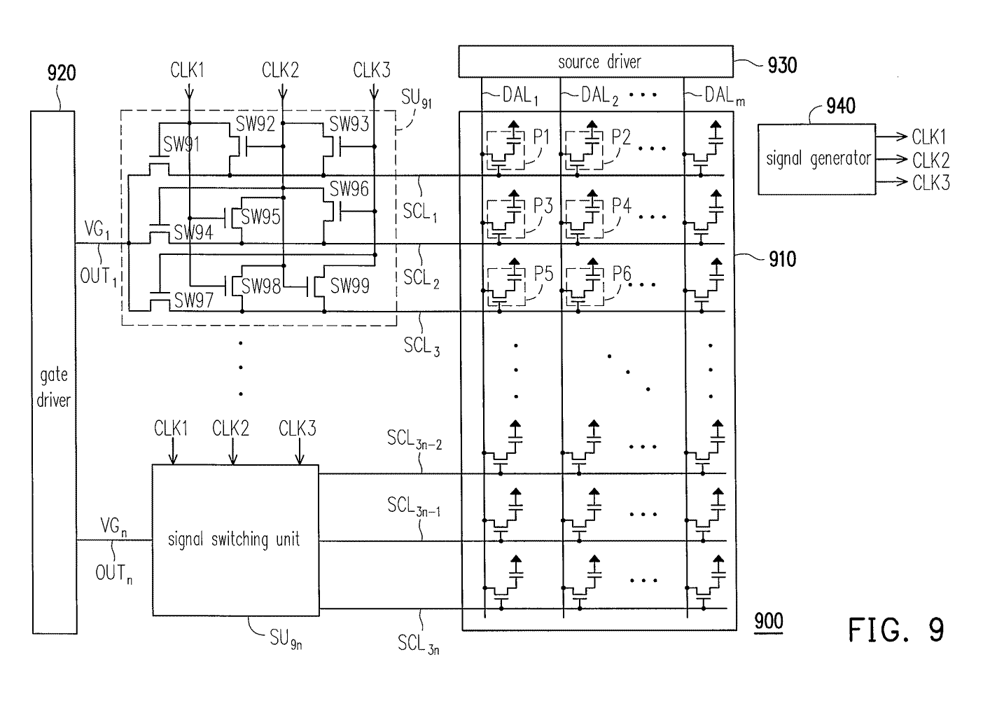

FIG. 9 is a circuit diagram of a flat panel display 900 according to another embodiment of the present invention. Referring to FIG. 9, a flat panel display 900 includes a display panel 910, a gate driver 920, a source driver 930, a signal generator 940 and signal switching units SU₉₁-SU₉ₙ. The display panel 910 has scan lines SCL₁-SCL3ₙ, data lines DAL₁-DALₘ and a plurality of pixel units (for example, the pixel units notated by P1-P6). The number n and m are positive integers.

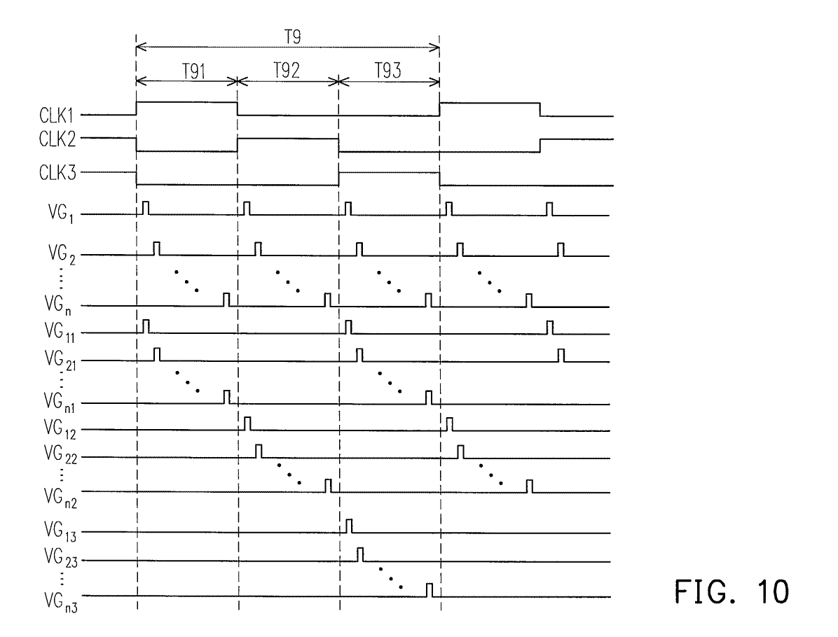

In the embodiment, the connection relation and the operation principle of the internal circuit are similar to the embodiment shown in FIG. 5, except a major difference that each of the signal switching units SU₉₁-SU₉ₙ has four terminals. The first terminal of the signal switching unit SU₉₁ is electrically connected to the output terminal OUT₁ of the gate driver 920, and the second, third, and fourth terminals of the signal switching unit SU₉₁ are respectively electrically connected to the scan line SCL₁-SCL₃. The connection relation of the signal switching units SU₉₂-SU₉ₙ are analogical to that of the signal switching units SU₉₁. Besides, as shown in FIG. 10, which is a signal timing diagram shows the signal timing of the embodiment of FIG. 9, a frame period T9 in the embodiment is divided into a preceding period T91, an intermediate period T92, and a rear period T93.

During the preceding period T91, the first and second terminals of the signal switching units SU₉₁-SU₉ₙ would be respectively turned on such that the gate signals VG₁-VGₙ are respectively passed to the scan lines SCL₁, SCL₄, . . . , SCL₃ₙ₋₂. Similarly, during the intermediate period T92, the first and third terminals of the signal switching units SU₉₁-SU₉ₙ would be respectively turned on so as to respectively pass the gate signals VG₁-VGₙ to the scan lines SCL₂, SCL₅, . . . , SCL₃ₙ₋₁. In addition, during the rear period T93, the first and fourth terminals of the signal switching units SU₉₁-SU₉ₙ would be respectively turned on to respectively pass the gate signals VG₁-VGₙ to the scan lines SCL₃, SCL₆, . . . , SCL₃ₙ.

On the other hand, as shown in FIG. 10, if the gate signals VG₁-VGₙ received by the display panel 910 within the preceding period T91 are re-named as VG₁₁-VGₙ₁, the gate signals VG₁-VGₙ received within the intermediate period T92 are re-named as VG₁₂-VGₙ₂, and the gate signals VG₁-VGₙ received within the rear period T93 are re-named as VG₁₃-VGₙ₃, then the source driver 930 sequentially drives the pixel units in the display panel 910 by passing the gate signals VG₁₁-VGₙ₁, VG₁₂-VGₙ₂ and VG₁₃-VGₙ₃ to the scan lines SCL₁-SCL₃ₙ.

In other words, based on the spirit of the present invention, when the display panel 910 of the flat panel display 900 has n scan lines, the gate driver 920 only requires n/3 output terminals to make the display panel 910 operable. Therefore in comparison with the prior art, the embodiment significantly reduces the number of the gate drivers employed in the flat panel display.

In terms of the internal circuit architecture of the signal switching units SU₉₁-SU₉ₙ of the present embodiment mentioned previously, for simplicity, only a signal switching unit SU₉₁ is exemplarily explained. Referring to FIG. 9, the signal switching unit SU₉₁ includes switches SW91-SW99 and each of the switches SW91-SW99 is formed by an NMOS transistor. The connection relations of the switches SW91-SW99 are similar to the embodiment in FIG. 5, and thereby the descriptions about the connections of the switches SW91-SW99 are omitted for a simplicity purpose.

Referring to FIGS. 9 and 10, during the preceding period T91, the control signals CLK2 and CLK3 are switched to the low level such that the switches SW91, SW95 and SW198 are respectively turned on, and the rest switches are turned off. Thus, the turned-on switch SW91 enables the scan line SCL₁ to receive the gate signal V_{G1}, and the turned-on switches SW95 and SW98 enable the scan lines SCL₂ and SCL₃ to respectively receive the control signal CLK2 and to be remained in the low level. Therefore, when the gate signal V_{G1} is applied during the preceding period T91, the pixel units P1 and P2 of the flat panel display 900 are driven in sequence. However, in the meanwhile, the pixel units P3-P6 are not driven since they are controlled by the control signal CLK2.

During the intermediate period T92, the control signal CLK2 is switched to the high level and the control signals CLK1 and CLK3 are switched to the low level. Therefore, the switches SW92, SW94 and SW99 are respectively turned on, while the rest switches are turned off. In addition, the turned-on switch SW94 enables the scan line SCL₂ to receive the gate signal V_{G1}, and the turned-on switches SW92 and SW99 enable the scan lines SCL₁ and SCL₃ to respectively receive the control signals CLK1 and CLK3 and to be remained in the low level. Therefore, when the gate signal V_{G1} is applied during the intermediate period T92, the pixel units P3 and P4 of the flat panel display 900 are driven in sequence. However, in the meanwhile, the pixel units P1-P2 and P5-P6 are not driven since they are controlled by the control signals CLK1 and CLK3.

Similarly, during the rear period T93, the control signal CLK3 is switched to the high level and the control signals CLK1 and CLK2 are switched to the low level. Therefore, the switches SW93, SW96 and SW97 are respectively turned on, and the rest switches are turned off. The turned-on switch SW97 enables the scan line SCL₃ to receive the gate signal V_{G1}, and the turned-on switches SW93 and SW96 enable the scan lines SCL₁ and SCL₂ to respectively receive the control signal CLK2 and to be remained in the low level. Therefore, when the gate signal V_{G1} is applied during the rear period T93, the pixel units P5 and P6 of the flat panel display 900 are driven in sequence. However, in the meanwhile, the pixel units P1-P4 are not driven since they are controlled by the control signal CLK2.

In summary, the present invention adopts the signal switching units to switch the transmission paths of the gate signals so that one gate signal is able to be delivered to different scan lines within a frame period. Therefore, the number of the gate drivers employed in a flat panel display could be significantly reduced. In addition, the present invention can be used in a conventional display panel to lower down the production cost and shorten the manufacturing schedule of a flat panel display without reducing the charging time of the pixel units.

The above described are preferred embodiments of the present invention only, which do not limit the implementation scope of the present invention. It will be apparent to those skilled in the art that various modifications and equivalent variations can be made to the structure of the present invention without departing from the scope or spirit of the invention.

What is claimed is:

1. A flat panel display, comprising:
a display panel, having a first scan line and a second scan line;
a gate driver, disposed at a side of the display panel and having at least an output terminal, wherein the gate driver outputs a gate signal through the output terminal;
a source driver, disposed at another side of the display panel and electrically connected to the display panel for driving the display panel in coordination with the gate signal; and
a signal switching unit, having a first terminal electrically connected to the output terminal of the gate driver, a second terminal electrically connected to the first scan line and a third terminal electrically connected to the second scan line, wherein the signal switching unit turns on the first terminal and the second terminal thereof during a preceding half period of a frame period and turns on the first terminal and the third terminal thereof during a rear half period of the frame period.

2. The flat panel display according to claim 1, wherein the signal switching unit comprises:
a first switch, having a first terminal electrically connected to the output terminal of the gate driver and a second terminal electrically connected to the first scan line, wherein the first switch is turned on during the preceding half period of the frame period;
a second switch, having a first terminal electrically connected to a control terminal of the first switch and a second terminal electrically connected to the first scan line, wherein the second switch is turned on during the rear half period of the frame period;
a third switch, having a first terminal electrically connected to the output terminal of the gate driver and a second terminal electrically connected to the second scan line, wherein the third switch is turned on during the rear half period of the frame period; and
a fourth switch, having a first terminal electrically connected to a control terminal of the third switch and a second terminal electrically connected to the second scan line, wherein the fourth switch is turned on during the preceding half period of the frame period.

3. The flat panel display according to claim 2, wherein the first switch, the second switch, the third switch and the fourth switch are respectively formed by an N-type transistor.

4. The flat panel display according to claim 1, further comprising:
a signal generator, electrically connected to the signal switching unit for generating control signals to control the signal switching unit.

5. The flat panel display according to claim 1, wherein the display panel is a liquid crystal display panel.

6. A flat panel display, comprising:
a display panel, having a first scan line and a second scan line;
a gate driver, disposed at a side of the display panel and having at least an output terminal, wherein the gate driver outputs a gate signal through the output terminal;
a source driver, disposed at another side of the display panel and electrically connected to the display panel for driving the display panel in coordination with the gate signal;
a signal generator, for generating a first control signal and a second control signal in sequence during a frame period; and
a signal switching unit, having a first terminal electrically connected to the output terminal of the gate driver, a second terminal electrically connected to the first scan line and a third terminal electrically connected to the second scan line, wherein the signal switching unit decides whether to turn on the first terminal and the second terminal thereof according to the first control signal, and whether to turn on the first terminal and the third terminal thereof according to the second control signal.

7. The flat panel display according to claim 6, wherein the signal switching unit comprises:
a first switch, electrically connected between the output terminal of the gate driver and the first scan line and having a control terminal for receiving the first control signal;
a second switch, electrically connected between the control terminal of the first switch and the first scan line and having a control terminal for receiving the second control signal;
a third switch, electrically connected between the output terminal of the gate driver and the second scan line and having a control terminal for receiving the second control signal; and
a fourth switch, electrically connected between the control terminal of the third switch and the second scan line and having a control terminal for receiving the first control signal.

8. The flat panel display according to claim 7, wherein the first switch, the second switch, the third switch and the fourth switch are respectively formed by an N-type transistor.

9. The flat panel display according to claim 6, wherein the display panel is a liquid crystal display panel.

10. A flat panel display, comprising:
a display panel, having a first scan line, a second scan line and a third scan line;
a gate driver, disposed at a side of the display panel and having at least an output terminal, wherein the gate driver outputs a gate signal through the output terminal;
a source driver, disposed at another side of the display panel and electrically connected to the display panel for driving the display panel in coordination with the gate signal; and
a signal switching unit, having a first terminal electrically connected to the output terminal of the gate driver, a second terminal electrically connected to the first scan line, a third terminal electrically connected to the second scan line and a fourth terminal electrically connected to the third scan line,
wherein the signal switching unit turns on the first terminal and the second terminal thereof during a preceding period of a frame period, turns on the first terminal and the third terminal thereof during an intermediate period of the frame period and turns on the first terminal and the fourth terminal thereof during a rear period of the frame period.

11. The flat panel display according to claim 10, wherein the signal switching unit comprises:
a first switch, having a first terminal electrically connected to the output terminal of the gate driver and a second terminal electrically connected to the first scan line, wherein the first switch is turned on during the preceding period of the frame period;
a second switch, having a first terminal electrically connected to a control terminal of the first switch and a second terminal electrically connected to the first scan line, wherein the second switch is turned on during the intermediate period of the frame period;
a third switch, having a first terminal electrically connected to a control terminal of the second switch and a second terminal electrically connected to the first scan line, wherein the third switch is turned on during the rear period of the frame period;
a fourth switch, having a first terminal electrically connected to the output terminal of the gate driver and a second terminal electrically connected to the second scan line, wherein the fourth switch is turned on during the intermediate period of the frame period;
a fifth switch, having a first terminal electrically connected to a control terminal of the fourth switch and a second terminal electrically connected to the second scan line, wherein the fifth switch is turned on during the preceding period of the frame period;
a sixth switch, having a first terminal electrically connected to the control terminal of the fourth switch and a second terminal electrically connected to the second scan line, wherein the sixth switch is turned on during the rear period of the frame period;
a seventh switch, having a first terminal electrically connected to the output terminal of the gate driver and a second terminal electrically connected to the third scan line, wherein the seventh switch is turned on during the rear period of the frame period;
an eighth switch, having a first terminal electrically connected to the control terminal of the fourth switch and a second terminal electrically connected to the third scan line, wherein the eighth switch is turned on during the preceding period of the frame period; and
a ninth switch, having a first terminal electrically connected to a control terminal of the sixth switch and a second terminal electrically connected to the third scan line, wherein the ninth switch is turned on during the intermediate period of the frame period.

12. The flat panel display according to claim 11, wherein the first switch to the ninth switch are respectively formed by an N-type transistor.

13. The flat panel display according to claim 10, further comprising:
a signal generator, electrically connected to the signal switching unit for generating control signals to control the signal switching unit.

14. The flat panel display according to claim 10, wherein the display panel is a liquid crystal display panel.

15. A flat panel display, comprising:
a display panel, having a first scan line, a second scan line and a third scan line;
a gate driver, disposed at a side of the display panel and having at least an output terminal, wherein the gate driver outputs a gate signal through the output terminal;
a source driver, disposed at another side of the display panel and electrically connected to the display panel for driving the display panel in coordination with the gate signal;
a signal generator for generating a first control signal, a second control signal and a third control signal in sequence during a frame period; and
a signal switching unit, having a first terminal electrically connected to the output terminal of the gate driver, a second terminal electrically connected to the first scan line, a third terminal electrically connected to the second scan line and a fourth terminal electrically connected to the third scan line,
wherein the signal switching unit decides whether to turn on the first terminal and the second terminal thereof according to the first control signal, whether to turn on the first terminal and the third terminal thereof according to the second control signal and whether to turn on the first terminal and the fourth terminal thereof according to the third control signal.

16. The flat panel display according to claim 15, wherein the signal switching unit comprises:
a first switch, electrically connected between the output terminal of the gate driver and the first scan line and having a control terminal for receiving the first control signal;
a second switch, electrically connected between the control terminal of the first switch and the first scan line and having a control terminal for receiving the second control signal;
a third switch, electrically connected between the control terminal of the second switch and the first scan line and having a control terminal for receiving the third control signal;
a fourth switch, electrically connected between the output terminal of the gate driver and the second scan line and having a control terminal for receiving the second control signal;
a fifth switch, electrically connected between the control terminal of the fourth switch and the second scan line and having a control terminal for receiving the first control signal;
a sixth switch, electrically connected between the control terminal of the fourth switch and the second scan line and having a control terminal for receiving the third control signal;
a seventh switch, electrically connected between the output terminal of the gate driver and the third scan line and having a control terminal for receiving the third control signal;
an eighth switch, electrically connected between the control terminal of the fourth switch and the third scan line and having a control terminal for receiving the first control signal; and
a ninth switch, electrically connected between the control terminal of the sixth switch and the third scan line and having a control terminal for receiving the second control signal.

17. The flat panel display according to claim 16, wherein the first switch to the ninth switch are respectively formed by an N-type transistor.

18. The flat panel display according to claim 15, wherein the display panel is a liquid crystal display panel.
